(19) United States
(12) Patent Application Publication
(10) Pub. No.: US 2014/0376644 A1
(43) Pub. Date: Dec. 25, 2014

(54) FRAME PACKING METHOD, APPARATUS AND SYSTEM USING A NEW 3D CODING "FRAME COMPATIBLE" FORMAT

(71) Applicant: S.I.SV.EL SOCIETA' ITALIANA PER LO SVILUPPO DELL'ELETTRONICA S.P.A., None (TO) (IT)

(72) Inventor: Paolo D'Amato Damato, Roma (IT)

(21) Appl. No.: 14/375,746

(22) PCT Filed: Feb. 15, 2013
(86) PCT No.: PCT/IB2013/051242

§ 371 Date: Jul. 30, 2014

(30) Foreign Application Priority Data
Feb. 16, 2012 (IT) TO2012A000134

(51) Int. Cl. H04N 19/597; H04N 13/00

(52) U.S. Cl. CPC H04N 19/00769; H04N 13/0029
USPC 375/240.26

(57) ABSTRACT

A frame packing method, apparatus and system are described, wherein, according to the packing method, the two images (L, R) of a stereoscopic pair are of the 1080i type and are entered into a container frame (C) of the 1080p type according to the top-bottom technique, wherein the odd, respectively even, active rows of one of the images (L,R) are entered into one half of the active part of said container frame (C) by observing the same order in which they are arranged in the image, and the odd, respectively even, active rows of the other one of the images (R,L) are entered into the other half of said active part of the container frame (C) by observing the same order in which they are arranged in the image, and the even, respectively odd, active rows of one of the images (L,R) are entered into one half of the active part of the next container frame (C+1) by observing the same order in which they are arranged in said image, and the even, respectively odd, active rows of the other one of the images (R,L) are entered into the other half of the active part of the next container frame (C+1) by observing the same order in which they are arranged in the image.

The present invention relates to a frame packing method, apparatus and system using a new 3D coding “frame compatible” format.

For transmission of 3D video streams, the so-called “frame compatible” formats are commonly used. Such formats allow to enter into a video frame, which is used as a container, the two images that make up the stereoscopic pair. In this way, the 3D video stream, consisting of two 2D video streams (one for the left eye and one for the right eye) becomes a single video stream and can therefore pass through the production and distribution infrastructures used for 2D TV and, most importantly, can be played by the 2D and 3D receivers currently available on the market, in particular for High Definition TV.

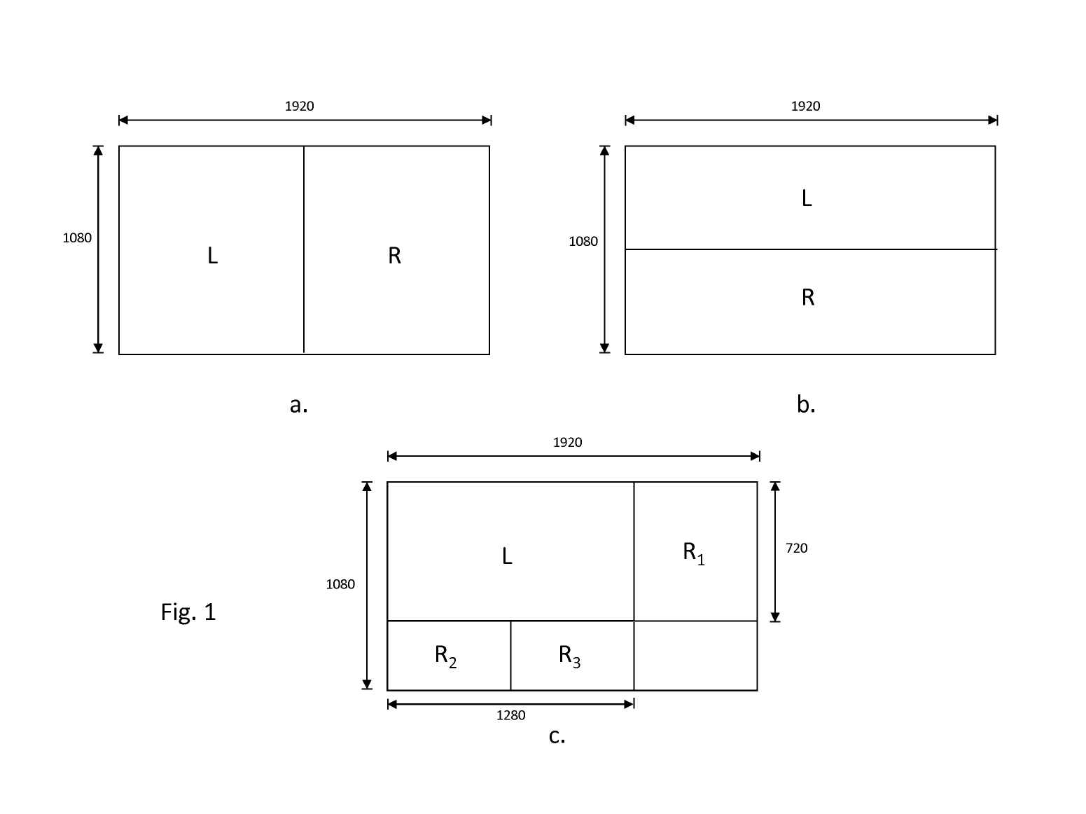

FIG. 1a and FIG. 1b schematically show two HD frames composed of 1920 columns by 1080 rows of pixels, which contain the two images that make up the stereoscopic pair, arranged in the two most common ways. In FIG. 1a, the two images for the left eye L (Left) and for the right eye R (Right) are entered one next to the other, thus creating the so-called “side by side” format, whereas in FIG. 1b they are entered one on top of the other, thus creating the so-called “top-bottom” format (also known as “over-under” format). Both of these formats have the drawback that they halve the resolution in one of the two directions, i.e. in the horizontal direction for the side by side format or in the vertical direction for the top-bottom format.

A third format, called “tile format”, has also been proposed, wherein two 720p images (1280×720 progressive-scan pixels) are entered into a 1080p container frame. According to such a format, one of the two images (L) is entered unchanged into the container, while the other one is divided into three parts (R₁, R₂, R₃), which are in turn entered into the space left available by the first image (see FIG. 1c). These entry operations are carried out at the frame rate frequency of the video stream involved, the typical values of which are 24, 50 or 60 Hz, depending on the adopted standard. Usually, the stream images are then compressed through a suitable coding and may be subjected to further treatments (multiplexing, channel coding, and the like) in order to be adapted for storage or transmission prior to reproduction.

The “tile format” differs from the other formats in that the container frame has a different format from the two component images, which undergo no decimation. In the most typical application, in fact, the format of the container is 1080p, while the format of the component images is 720p. It is apparent that a 1080p container (i.e. a progressive video) may also contain two interlaced images, i.e. of the 1080i type, with a halved frame rate. However, this type of frame packing has not been sufficiently studied yet, although it appears to be attractive for those broadcasters who have chosen the 1080i format for high definition and want to keep using the same format also for the two images that make up the stereoscopic pair.

These frame packing formats using 1080p as a container can be defined as “second generation” formats. Their use is interesting in both the distribution and production environments. It must be pointed out that all frame packing formats suffer from the drawback that they do not allow, at the compression stage, to exploit the so-called “interview” redundancies, i.e. they do not allow to exploit the similarities between the two images of the stereoscopic pair. For this reason, it has been proposed to use, for distribution, the so-called MVC (Multi View Coding) compression system in its “stereo high profile” version, wherein there are only two views because such a format allows to exploit said redundancies. In other people's opinion, the advantages deriving from MVC are limited, in that the bit-rate gain thus obtained is small, whereas the complexity of the encoder and of the decoder increases significantly.

In any case, even if MVC is used for distribution, in order to circulate a 3D signal in the same systems used for HDTV it is appropriate to use a frame packing solution for production. If MVC is used in the 2×720p version, the tile format is well suited to be used as a production format. Vice versa, if MVC is used in the 2×1080i version, it will be necessary to use the new format mentioned above.

It is therefore an object of the present invention to solve the above-mentioned problems of the prior art by providing a frame packing method, apparatus and system using a new 3D coding “frame compatible” format, wherein the composite signal obtained contains a signalling that defines the adopted packing type, and wherein the encoder, upon receiving said signalling, applies the coding algorithms typical of an interlaced signal to the composite signal, the signal to be coded being nevertheless of the progressive type.

These and other objects and advantages of the invention, which will become apparent from the following description, are achieved through a frame packing method as set out in claim 1.

In addition, these and other objects and advantages of the invention are achieved through a frame packing apparatus as set out in claim 19.

Finally, these and other objects and advantages of the invention are achieved through a frame packing system as set out in claim 30.

Preferred embodiments and non-obvious variants of the present invention are specified in dependent claims.

It is understood that all the appended claims are an integral part of the present description.

It will become immediately apparent that what is described herein may be subject to innumerable variations and modifications (e.g. in shape, dimensions, arrangements and parts having equivalent functionality) without departing from the protection scope of the invention as set out in the appended claims.

The present invention will be described in detail below through some preferred embodiments thereof, which are only provided by way of non-limiting example, with reference to the annexed drawings, wherein:

FIGS. 1a and 1b show two HD frames composed of 1920 columns by 1080 rows of pixels (referred to as 1080p), respectively belonging to the video stream for the left eye L and for the right eye R;

FIG. 1c illustrates the so-called “tile format”;

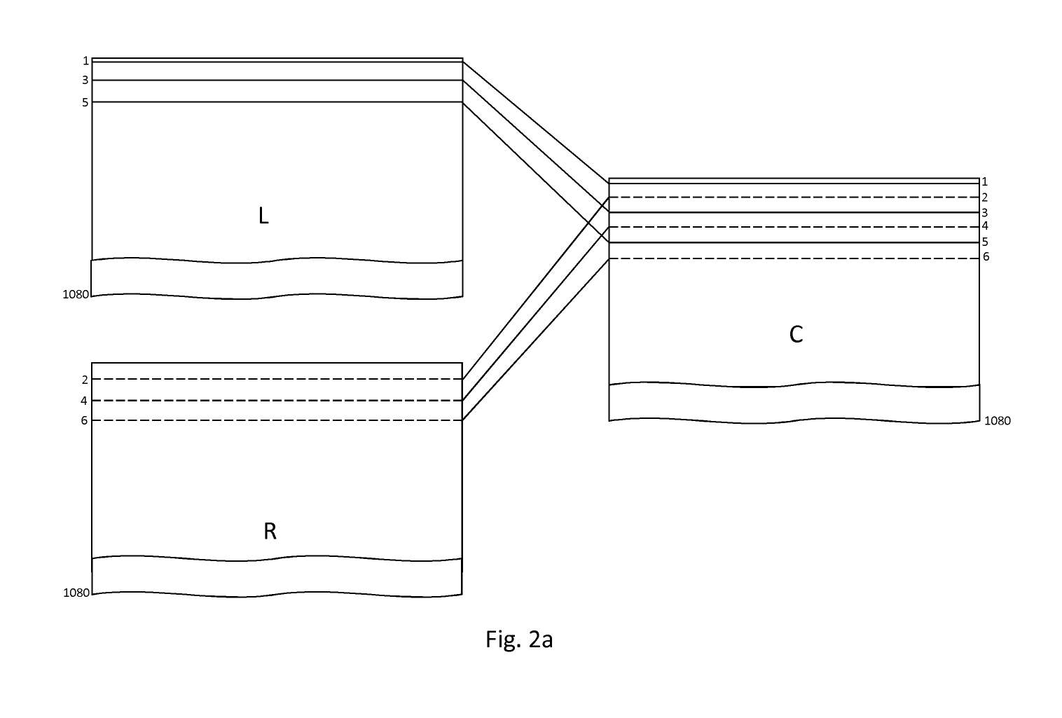

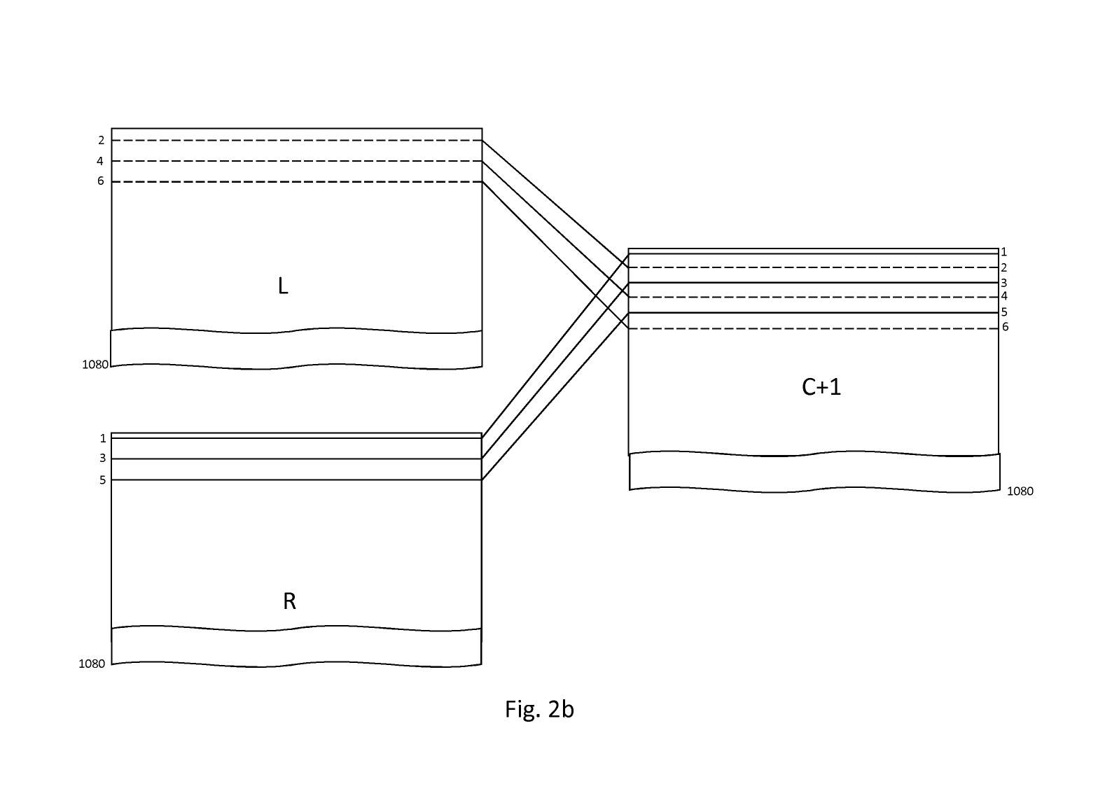

FIGS. 2a and 2b show a known interleaving process for entering two 1080i images into a 1080p frame;

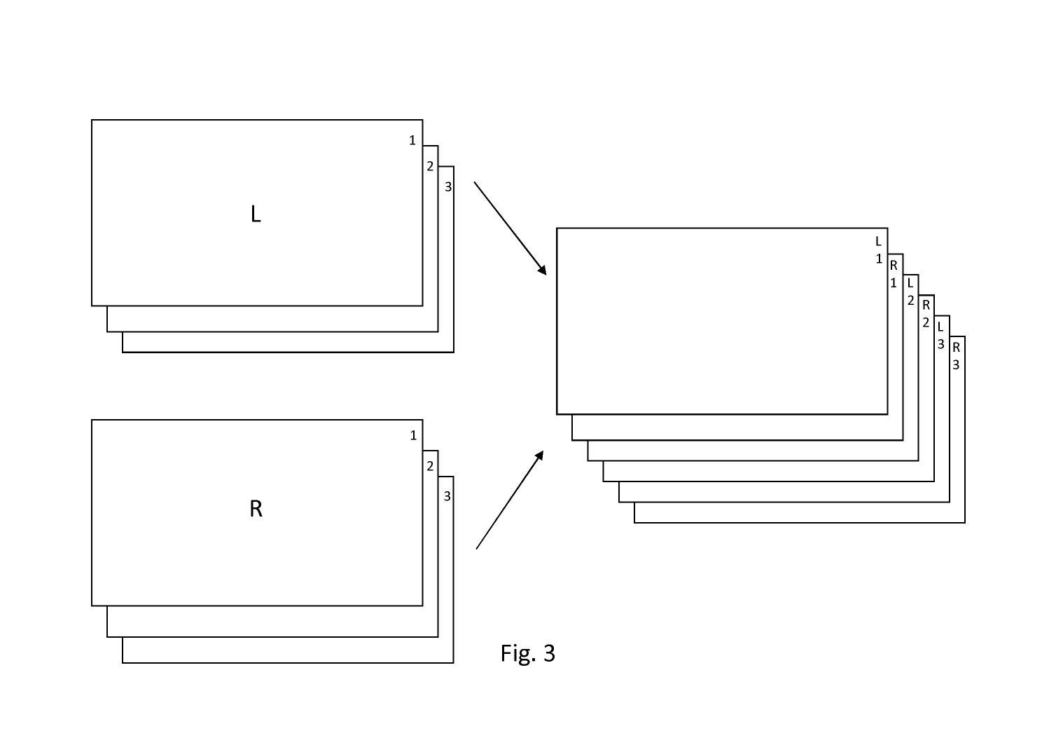

FIG. 3 illustrates the so-called “frame alternate” method;

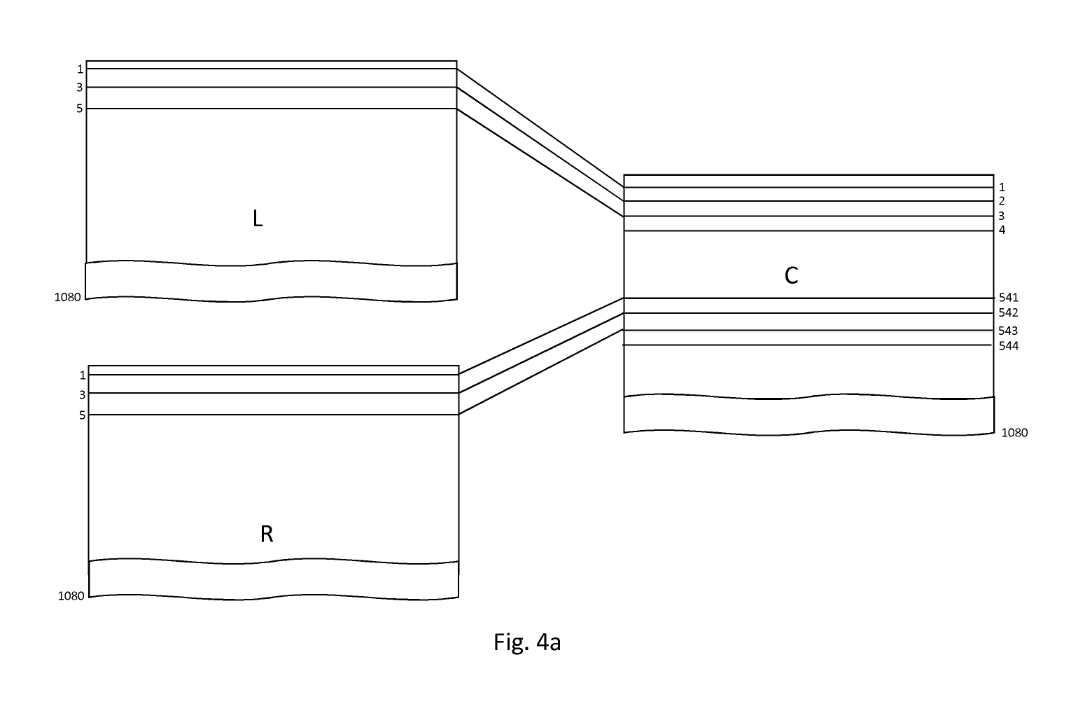

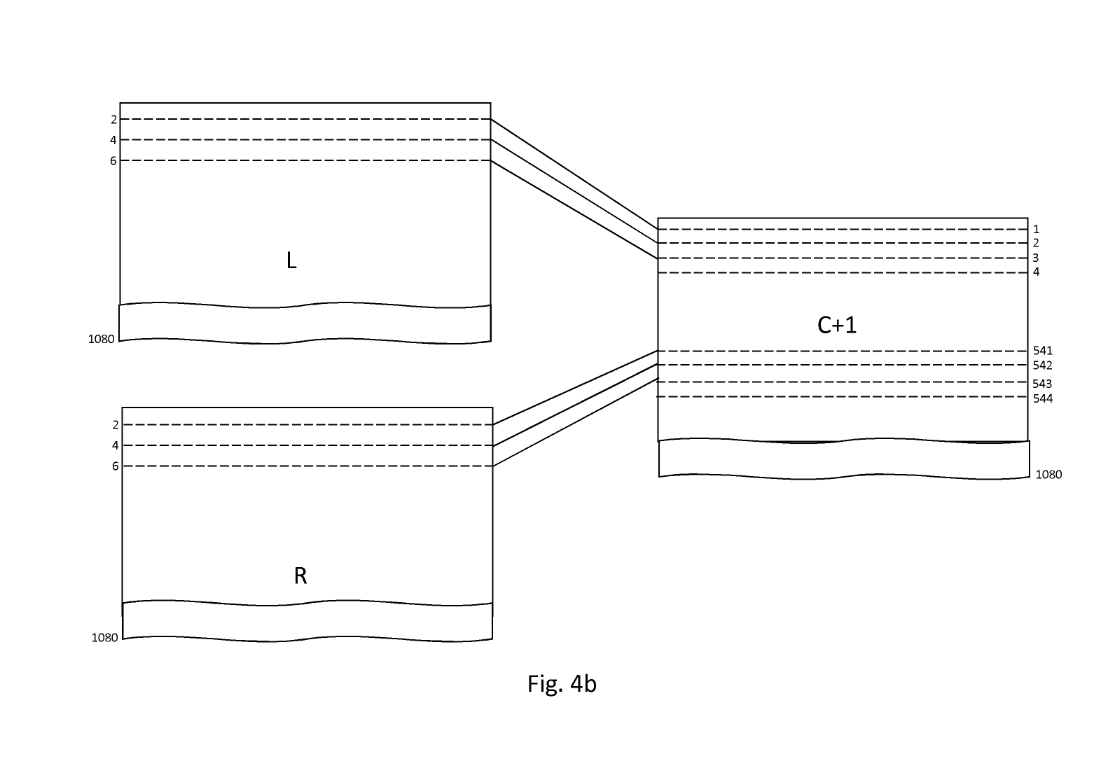

FIGS. 4a and 4b illustrate the frame packing method of the present invention.

FIGS. 1a to 1c have already been described above in the paragraphs discussing the prior art.

In order to be able to enter two 1080i images into a 1080p container, it has been proposed in the art to use some sort of interleaving between two interlaced frames: in other words, the odd rows of the left image (L) and the even rows of the right image (R) are entered into a container frame C, and the even rows of the image L and the odd rows of the image R are entered into the next frame (C+1) (see FIGS. 2a and 2b). A signal which is very difficult to compress is thus obtained, in that the interleaving step eliminates the vertical spatial correlation; as a consequence, for the compressed signal to have an acceptable quality, it is necessary to employ a very high bit-rate.

It is therefore preferable to use a new form of top-bottom format, wherein, in a frame C, the odd active rows of the image L are copied into the upper half of the active part of said frame C (FIG. 4a) by observing the same order in which they are arranged in said image L, and the odd active rows of the image R are copied into the lower half of the active part of said frame C by observing the same order in which they are arranged in said image R.

In the next frame C+1, the even active rows of the image L are copied into the upper half of the active part of said frame C+1 by observing the same order in which they are arranged in said image L, and the even active rows of the image R are copied into the lower half of the active part of said frame C+1 by observing the same order in which they are arranged in said image R.

In a first alternative embodiment of the invention, in the frame C, the odd active rows of the image R are copied into the upper half of the active part of said frame C by observing the same order in which they are arranged in said image R, and the odd active rows of the image L are copied into the lower half of the active part of said frame C by observing the same order in which they are arranged in said image L. As a consequence, in the next frame C+1, the even active rows of the image R are copied into the upper half of the active part of said frame C+1 by observing the same order in which they are arranged in said image R, and the even active rows of the image L are copied into the lower half of the active part of said frame C+1 by observing the same order in which they are arranged in said image L.

In a second alternative embodiment of the invention, in the frame C, the even active rows of the image L are copied into the upper half of the active part of said frame C by observing the same order in which they are arranged in said image, and the even active rows of the image R are copied into the lower half of the active part of said frame C by observing the same order in which they are arranged in said image R. As a consequence, in the next frame C+1, the odd active rows of the image L are copied into the upper half of the active part of said frame C+1 by observing the same order in which they are arranged in said image, and the odd active rows of the image R are copied into the lower half of the active part of said frame C+1 by observing the same order in which they are arranged in said image R.

In a third alternative embodiment of the invention, in the frame C, the even active rows of the image R are copied into the upper half of the active part of said frame C by observing the same order in which they are arranged in said image, and the even active rows of the image L are copied into the lower half of the active part of said frame C by observing the same order in which they are arranged in said image L. As a consequence, in the next frame C+1, the odd active rows of the image R are copied into the upper half of the active part of said frame C+1 by observing the same order in which they are arranged in said image, and the odd active rows of the image L are copied into the lower half of the active part of said frame C+1 by observing the same order in which they are arranged in said image L.

Each one of the above arrangements advantageously preserves the vertical spatial correlation, and therefore causes no problems in the compression process.

Also advantageously, the process of compressing the signal obtained in accordance with the invention can be carried out by using the algorithms typically employed for an interlaced signal, even if the signal to be compressed is structured like a progressive signal. However, this cannot be done by using the current standards unless a number of variants are introduced, which will now be described.

Such variants should be introduced both into the SMPTE standard, at the processing stage that defines the frame packing systems to be used for production, and into the compression standards used for distribution (MPEG2, AVC—Advanced Video Coding—and possibly also the new standard still under development, known as HEVC—High Efficiency Video Coding—).

First of all, it is necessary to introduce a signalling that identifies the new frame packing type adopted, i.e. a signalling to indicate the transmission of a 1080p composite frame containing two 1080i images making up a stereoscopic pair, arranged in the frame according to the “top-bottom” format, i.e. one on top of the other. Of course, the type of signalling depends on the standard taken into consideration. For example, in the case of the AVC (ITU-T H.264) standard, one may use the “frame_packing_arrangement_type” parameter, which is included in the so-called SEI (Supplemental Enhancement Information) messages. This parameter defines the various allowable frame packing types and may have different values, most of which are not used. It will be sufficient to choose one of the unused values and then use it to define the new frame packing type according to the invention.

Still with reference to the H.264 standard, the two component images are defined as “0” and “1”, and there is another parameter that indicates which one of the two component images “0” and “1” is the image L for the left eye and which one is the image R. These very same parameters can be used in the SMPTE HD-SDI and 3G-SDI interfaces currently used in the production environment: in such a case, said parameters are entered into an “ancillary data packet” located in the horizontal blanking, just like any other signalling identifying the characteristics of the video signal being transported.

It is important to underline that the encoder, when it receives a signal according to the invention through the 3G-SDI interface defined by SMPTE, should preferably code it as if it were an interlaced signal, although the signal is structured like a progressive signal. For example, a typical way of coding interlaced signals is to make, for each macroblock, a “motion detection” operation: this operation allows to identify the static areas of the image and those containing motion.

For static areas, it is possible to arrange together the pixels of the two even and odd half-frames (fields), and then treat such areas as if they were included in a progressive image. For moving areas, instead, the two half-frames are coded as if they were two different images. For example, in time prediction, the macroblock of one of the previous half-frames of the same type is searched for, and then the corresponding “motion vector” is calculated.

Since the 3D video signal consists of a succession of frames alternately containing the odd and even half-frames of the two component signals, it is necessary to signal, for at least one of two consecutive frames C,C+1, which type of half-frame it contains. For this purpose a new parameter may be used, or one of the existing parameters may be recycled by giving a new meaning to it.

In both the AVC and SMPTE standards, one of the various frame packing types taken into consideration is the so-called “frame alternate”, i.e. a signal containing a succession of frames alternately belonging to the image L and to the image R (FIG. 3).

This is a different case from the one of the present invention; in this case as well, however, there is a need for identifying which image is contained in each frame. In other words, it is necessary to define a parameter indicating, in a “frame alternate” system, which is the current frame (either the one containing the image L or the one containing the image R). This very same parameter may be used, with a different meaning, in the present invention; more precisely, when the “frame_packing_arrangement_type” parameter takes the value used for defining the new frame packing type of the invention, then the parameter in question may indicate whether the current frame contains the odd half-frames or the even half-frames.

Of course, in order to define the parameters required for identifying the new format and handle it properly, many solutions are possible, which also depend on the various standards involved; nevertheless, the principle underlying the various possible solutions always remains the same, thus still falling within the protection scope of the patent.

In summary, an innovative frame packing method has been described, wherein the two images of a stereoscopic pair are of the 1080i type and are entered into a container frame of the 1080p type by using the “top-bottom” technique, wherein the active rows of the odd half-frames of said images are entered into a container frame, and the active rows of the even half-frames of said images are entered into the next container frame. The vertical blanking interval remains the one which is characteristic of a signal in the 1080p format.

The composite signal thus obtained contains a signalling that defines the type of packing adopted, so that an encoder, upon receiving said signalling, can apply the coding algorithms typical of an interlaced signal to said composite signal, the signal to be coded being nevertheless of the progressive type.

In particular, said method also includes a signalling that indicates, for each frame, the type of half-frame it contains, said half-frame being of the odd or even type.

More in particular, said method also includes a signalling indicating which one of the two images L,R is at the top and which one is at the bottom.

The invention also relates to a frame packing apparatus, wherein the two images of a stereoscopic pair are of the 1080i type, comprising means for entering said images into a container frame of the 1080p type by using the “top-bottom” technique, wherein the active rows of the odd half-frames of said images are entered into a container frame, and the active rows of the even half-frames of said images are entered into the next container frame.

Said apparatus also comprises means adapted to add to a composite signal thus obtained a signalling defining the adopted packing type, said signalling being adapted to cause an encoder, upon receiving said signalling, to apply the coding algorithms typical of an interlaced signal to said composite signal, the signal to be coded being nevertheless of the progressive type.

In particular, said apparatus also includes a signalling that indicates, for each frame, the type of half-frame it contains, said half-frame being of the odd or even type. Furthermore, said apparatus also includes a signalling indicating which one of the two images is at the top and which one is at the bottom.

The invention further relates to a system comprising a frame packing apparatus like the one illustrated above and an encoder which, after having identified the particular packing method adopted, applies the algorithms typical of an interlaced signal to the composite signal, the composite signal being nevertheless of the progressive type.

The stereoscopic video stream generated in accordance with the packing and coding method is transmitted via a communication channel and is received by a decoder adapted to generate a composite video signal and comprising means for receiving a stereoscopic video stream packed and coded in accordance with the above-described method, means for decoding the stereoscopic video stream, and means for outputting a composite video signal comprising the signalling entered during the step of packing and coding the composite video signal.

The video signal thus extracted is then sent to the input of an unpacking device adapted to generate a signal in a video format that can be used by a display device. Said unpacking device comprises means for receiving the composite video signal packed in accordance with the above-described frame packing method, and means for interpreting the signalling associated with said composite video signal. Said signalling contains the information necessary for the proper operation of the unpacker, which must execute operations which are the exact inverse of those executed by the packer. A complete reception system comprises said decoder, said unpacking device and the display device. In practical implementations, the decoder may be a set-top-box and the unpacker may be included in the display device; it may also be the case that the set-top-box contains, in addition to the decoder, also the unpacking device; finally, it may also happen that the decoder and the unpacking device together constitute a single apparatus.

1. A frame packing method, wherein the two images of a stereoscopic pair are of the 1080i type and are entered into a container frame of the 1080p type according to the top-bottom technique, wherein the odd, respectively even, active rows of one of the images are entered into one half of the active part of said container frame by observing the same order in which they are arranged in said image, and the odd, respectively even, active rows of the other one of the images are entered into the other half of said active part of said container frame by observing the same order in which they are arranged in said image, and the even, respectively odd, active rows of one of the images are entered into one half of the active part of the next container frame by observing the same order in which they are arranged in said image, and the even, respectively odd, active rows of the other one of the images are entered into the other half of said active part of the next container frame by observing the same order in which they are arranged in said image.

2. A method according to claim 1, wherein a signaling is associated with at least one of said container frames.

3. A method according to claim 2, wherein said signalling comprises a first parameter identifying the various allowable frame packing types.

4. A method according to claim 2, wherein said signalling comprises a second parameter indicating, for each frame, the type of active rows, whether even or odd, that it contains.

5. A method according to claim 2, wherein said signalling comprises a third parameter indicating, within a container frame, which half of said container frame contains the active rows derived from one of the two images.

6. A method according to claim 5, wherein said two images are defined as “0” and “1” and said signalling comprises an additional parameter indicating which image is intended for the left eye and which image is intended for the right eye.

7. A method according to claim 3, wherein said packing method is adapted to generate a composite video signal and said first and/or second and/or third parameters are entered into data fields of said composite video signal.

8. A method according to claim 7, wherein said first and/or second and/or third parameters are entered into an ancillary data packet located in the horizontal blanking of said composite video signal.

9. A method according to claim 7, wherein said first and/or second and/or third parameters are entered into a SEI, or Supplemental Enhancement Information, field of the AVC standard of said composite video signal.

10. A frame packing and coding method adapted to generate a stereoscopic video stream, wherein the two images of a stereoscopic pair are of the 1080i type and are entered into a container frame of the 1080p type according to the top-bottom technique, wherein the odd, respectively even, active rows of one of the images are entered into one half of the active part of said container frame by observing the same order in which they are arranged in said image, and the odd, respectively even, active rows of the other one of the images are entered into the other half of said active part of said container frame by observing the same order in which they are arranged in said image, and the even, respectively odd, active rows of one of the images are entered into one half of the active part of the next container frame by observing the same order in which they are arranged in said image, and the even, respectively odd, active rows of the other one of the images are entered into the other half of said active part of the next container frame by observing the same order in which they are arranged in said image, wherein said composite video signal, consisting of the sequence of said container frames, comprises a signalling, and wherein an encoder, upon receiving said signalling, applies coding algorithms typical of an interlaced signal to said composite video signal, the signal to be coded being nevertheless of the progressive type.

11. A packing and coding method according to claim 10, wherein said signalling comprises a first parameter identifying the various allowable frame packing types.

12. A packing and coding method according to claim 10, wherein said signalling comprises a second parameter indicating, for each frame, the type of active rows, whether even or odd, that it contains.

13. A packing and coding method according to claim 10, wherein said signalling comprises a third parameter indicating, within a container frame, which half of said container frame contains the active rows derived from one of the two images.

14. A packing and coding method according to claim 13, wherein said two images are defined as “0” and “1” and said signalling comprises an additional parameter indicating which image is intended for the left eye and which image is intended for the right eye.

15. A packing and coding method according to claim 11, wherein said first and/or second and/or third parameters are entered into data fields of said composite video signal.

16. A packing and coding method according to claim 15, wherein said first and/or second and/or third parameters are entered into an ancillary data packet located in the horizontal blanking of said composite video signal.

17. A method according to claim 15, wherein said first and/or second and/or third parameters are comprised in a SEI, or Supplemental Enhancement Information, field of the AVC standard of said composite video signal.

18. A method for coding a composite video signal as generated by a frame packing method according to claim 1, wherein the packing type of said frame is identified and algorithms typical of an interlaced signal are applied to the composite video signal, the composite video signal being nevertheless of the progressive type.

19. A frame packing apparatus adapted to generate a composite video signal, wherein the two images of a stereoscopic pair are of the 1080i type and means are provided for entering said two images into a container frame of the 1080p type according to the top-bottom technique, wherein means are provided for entering the odd, respectively even, active rows of one of the images into one half of the active part of said container frame by observing the same order in which they are arranged in said image, and for entering the odd, respectively even, active rows of the other one of the images into the other half of said active part of said container frame by observing the same order in which they are arranged in said image, and for entering the even, respectively odd, active rows of one of the images into one half of the active part of the next container frame by observing the same order in which they are arranged in said image, and for entering the even, respectively odd, active rows of the other one of the images into the other half of said active part of the next container frame by observing the same order in which they are arranged in said image.

20. An apparatus according to claim 19, wherein means are provided for associating a signalling with at least one of said container frames.

21. An apparatus according to claim 19, wherein said signalling comprises a first parameter identifying the various allowable frame packing types.

22. An apparatus according to claim 20, wherein said signalling comprises a second parameter indicating, for each frame, the type of active rows, whether even or odd, that it contains.

23. An apparatus according to claim 20, wherein said signalling comprises a third parameter indicating, within a container frame, which half of said container frame contains the active rows derived from one of the two images.

24. An apparatus according to claim 23, wherein said two images are defined as “0” and “1” and said signalling comprises an additional parameter indicating which image is intended for the left eye and which image is intended for the right eye.

25. An apparatus according to claim 21, wherein means are provided for entering said first and/or second and/or third parameters into data fields of said composite video signal.

26. An apparatus according to claim 25, wherein means are provided for entering said first and/or second and/or third parameters into an ancillary data packet located in the horizontal blanking of said composite video signal.

27. A frame packing apparatus according to claim 19, wherein said composite video signal is in accordance with the 3G-SDI interface of the SMPTE standard.

28. An encoder adapted to receive a composite video signal as generated by a frame packing apparatus according to claim 19, comprising means for identifying the packing type of said frames and for applying algorithms typical of an interlaced signal to the composite video signal, the composite video signal being nevertheless of the progressive type.

29. An encoder according to claim 28, comprising means for entering said first or second or third parameters into a data field of the output video stream.

30. An encoder according to claim 28, comprising means for entering said first or second or third parameters into SEI, or Supplemental Enhancement Information, messages of the AVC standard.

31. A system comprising a frame packing apparatus and an encoder, said apparatus being adapted to generate a composite video signal, wherein the two images of a stereoscopic pair are of the 1080i type and means are provided for entering said two images into a container frame of the 1080p type according to the top-bottom technique, wherein means are provided for entering the odd, respectively even, active rows of one of the images into one half of the active part of said container frame by observing the same order in which they are arranged in said image, and for entering the odd, respectively even, active rows of the other one of the images into the other half of the active part of said container frame by observing the same order in which they are arranged in said image, and for entering the even, respectively odd, active rows of one of the images into one half of the active part of the next container frame by observing the same order in which they are arranged in said image, and for entering the even, respectively odd, active rows of the other one of the images into the other half of the active part of the next container frame by observing the same order in which they are arranged in said image, and wherein said composite video signal consists of the sequence of said container frames, and wherein said system comprises means adapted to enter a signalling into the composite video signal, said signalling being used by the encoder, which comprises means for receiving said signalling and for applying algorithms typical of an interlaced signal to said composite video signal, the signal to be coded being nevertheless of the progressive type.

32. A decoder adapted to generate a composite video signal, comprising:
means for receiving at its input a stereoscopic video stream packed and coded in accordance with claim 10;
means for decoding said stereoscopic video stream;
means for outputting a composite video signal comprising said signalling.

33. An unpacking device adapted to generate a signal in a video format that can be used by a display device, comprising means for receiving at its input a composite video signal packed in accordance with claim 1.

34. (canceled)

35. (canceled)
